(19) United States
(12) Patent Application Publication
(10) Pub. No.: US 2024/0362441 A1
(43) Pub. Date: Oct. 31, 2024

(54) Indicia Decoding Device with Depth Perception

(71) Applicant: ZEBRA TECHNOLOGIES CORPORATION, Lincolnshire, IL (US)

(72) Inventors: Edward Barkan, Miller Place, NY (US); Darran Michael Handshaw, Sound Beach, NY (US); Mark Drzymala, Saint James, NY (US); David P. Goren, Smithtown, NY (US); Binyamin Stein, Flushing, NY (US)

(21) Appl. No.: 18/140,550

(22) Filed: Apr. 27, 2023

(51) Int. Cl. G06K 7/14; G06T 7/40; G06T 7/50; G06T 7/62; G06V 10/74; G06V 40/10

(52) U.S. Cl. CPC G06K 7/1443; G06T 7/40; G06T 7/50; G06T 7/62; G06V 10/761; G06V 40/107; G06T 2207/30242; G06V 2201/07

(57) ABSTRACT

The present disclosure provides new and innovative devices, methods, and apparatuses for discerning the presence and characteristics of objects that are passing in front of an indicia decoding device. In an example, a device comprises a 2D imaging assembly, a depth imaging assembly, and a processing device configured to analyze data from the depth imaging assembly to determine a number of items that are in a field of view of the depth imaging assembly during a period of time, analyze data from the 2D imaging assembly to determine a number of indicia that are present in a field of view of the 2D imaging assembly during at least a portion of the period of time, compare the number of indicia with the number of items, output a determination as to whether the number of indicia matches the number of items, and responsive to determining that the number of indicia does not match the number of items, transmit a message to an alert module.

### BACKGROUND

Indicia decoding is a process by which information which is visually encoded on an item can be easily and quickly discerned by a computerized system. Common settings which employ indicia decoding devices include inventory management and retail, among many others. In retail settings, indicia decoding devices can commonly be found in self-service kiosks which operate with minimal supervision from store employees.

### SUMMARY

The present disclosure provides new and innovative devices, methods, and apparatuses for discerning the presence and characteristics of objects that are passing in front of an indicia decoding device. In an example, a device comprises a 2D imaging assembly, a depth imaging assembly, and a processing device configured to analyze data from the depth imaging assembly to determine a number of items that are in a field of view of the depth imaging assembly during a period of time, analyze data from the 2D imaging assembly to determine a number of indicia that are present in a field of view of the 2D imaging assembly during at least a portion of the period of time, compare the number of indicia with the number of items, output a determination as to whether the number of indicia matches the number of items, and responsive to determining that the number of indicia does not match the number of items, transmit a message to an alert module.

In an example, a computer-implemented method comprises receiving data from a depth imaging assembly and a 2D imaging assembly, analyzing the data to determine a number of items that are in a field of view of the depth imaging assembly during a period of time and a number of indicia that are present in a field of view of the 2D imaging assembly during at least a portion of the period of time, comparing the number of indicia with the number of items, determining whether the number of indicia matches the number of items, and responsive to a determination that the number of indicia does not match the number of items, transmitting a message to an alert module.

In an example, an apparatus includes a non-transitory computer readable medium containing instructions which, when executed by a processing device, cause the processing device to analyze data from a depth imaging assembly to determine a number of items that are in a field of view of the depth imaging assembly during a period of time, wherein the processing device discerns a boundary between items at least partially by detecting a gap in a measured depth that exceeds a predetermined threshold, analyze data from a 2D imaging assembly to determine a number of indicia that are present in a field of view of the 2D imaging assembly during at least a portion of the period of time, wherein the processing device determines whether multiple indicia are affixed to a single item, and responsive to determining that multiple indicia are affixed to the single item, the processing device includes one of the multiple indicia in consideration when determining the number of indicia and excludes additional indicia of the multiple indicia from consideration when determining the number of indicia, compare the number of indicia with the number of items, output a determination as to whether the number of indicia matches the number of items, and responsive to determining that the number of indicia does not match the number of items, transmit a message to an alert module.

Additional features and advantages of the disclosed devices, methods, and apparatuses are described in, and will be apparent from, the following Detailed Description and the Figures. The features and advantages described herein are not all-inclusive and, in particular, many additional features and advantages will be apparent to one of ordinary skill in the art in view of the Figures and the Detailed Description. Moreover, it should be noted that the language used in this specification has been principally selected for readability and instructional purposes, and not to limit the scope of the inventive subject matter.

### BRIEF DESCRIPTION OF THE FIGURES

The description will be more fully understood with reference to the following figures, which are presented as exemplary aspects of the disclosure and should not be construed as a complete recitation of the scope of the disclosure, wherein:

FIG. 1 illustrates an example indicia decoding device and various items of different shapes which may have indicia, according to an example embodiment of the present disclosure.

FIG. 2 illustrates an example indicia decoding device data flow when viewing two items side-by-side, according to an example embodiment to the present disclosure.

FIG. 3 illustrates an example indicia decoding device data flow when viewing a single item with multiple indicia, according to an example embodiment of the present disclosure.

FIG. 4 illustrates an example indicia decoding device data flow when viewing an item and a human hand, according to an example embodiment of the present disclosure.

FIG. 5 illustrates an example indicia decoding device data flow when viewing two items with different formats of indicia, according to an example embodiment of the present disclosure.

FIG. 6 illustrates an example indicia decoding device data flow when viewing an item that does not match an expected shape associated with an indicium affixed to the item, according to an example embodiment of the present disclosure.

FIG. 7 illustrates a flow chart of an example method for discerning the presence of multiple objects within a field of view of an imaging device for use with indicia decoding, according to an example embodiment of the present disclosure.

FIG. 8 illustrates a flow chart of a collection of example methods for analyzing data from an imaging device for use with indicia decoding, according to an example embodiment of the present disclosure.

FIG. 9 illustrates a flow chart of an example method for analyzing data from an imaging device for use with indicia decoding, according to an example embodiment of the present disclosure.

### DETAILED DESCRIPTION

Devices and techniques are disclosed herein for discerning the presence and characteristics of objects that are passing in front of an indicia decoding device. Indicia decoding devices are often deployed in settings such as self-service checkouts where one employee may be supervising many indicia decoding kiosks. Additionally, users of indicia decoding kiosks in these settings vary widely in their skill level when interacting with decoding equipment and their motivations in doing so.

Inexperienced and unaware users of self-service indicia decoding devices may erroneously think that an indicium affixed to an item has been decoded and move onto a subsequent item. It will be apparent to those of skill in the art that it important that indicia associated with inventory management be accurately decoded. It is therefore desirable to implement a device that can automatically verify that an indicium has been decoded for every item that passes in front of an indicia decoding device. Automation of this process can significantly improve the efficacy of decoding devices and reduce the rate of accidental non-decode events that can result in a loss of inventory.

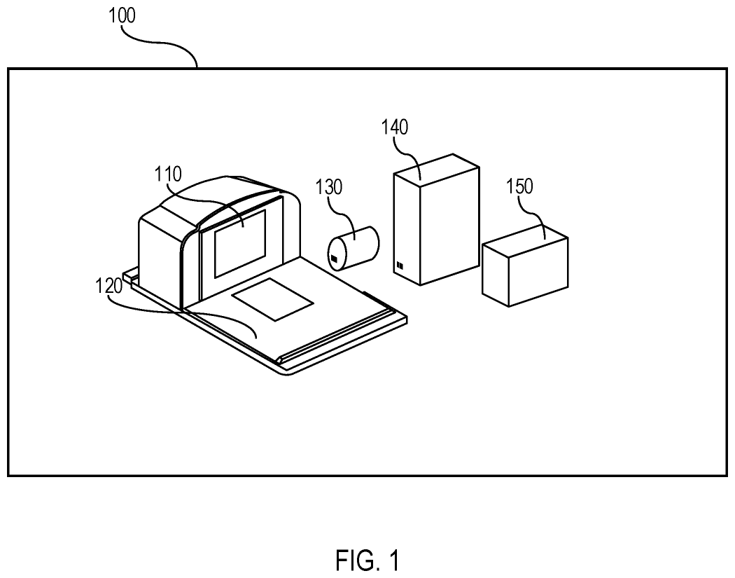

FIG. 1 illustrates an example indicia decoding device 100 and various items of different shapes which may have indicia, according to an example embodiment of the present disclosure. In this example, the various items comprise a cylindrical item 130 with an indicium, a first rectangular item 140 with an indicium, and a second rectangular item 150 without an indicium. The indicia decoding device 100 includes a viewing window 110 and a platter 120.

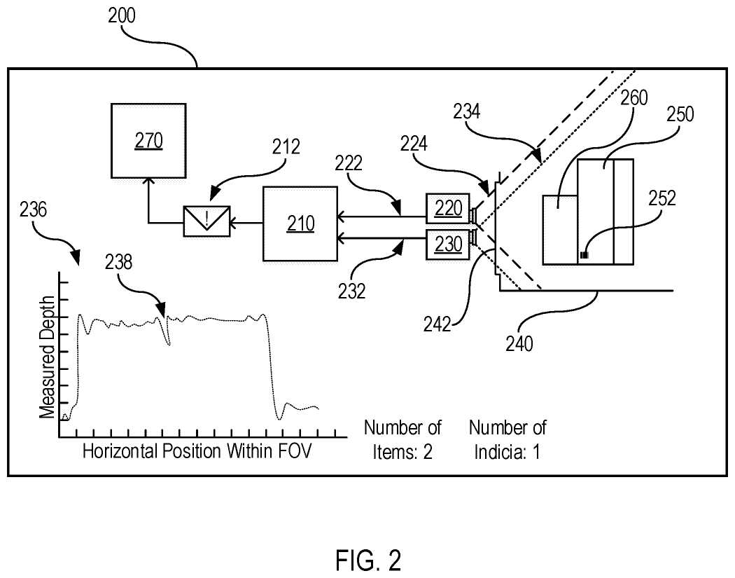

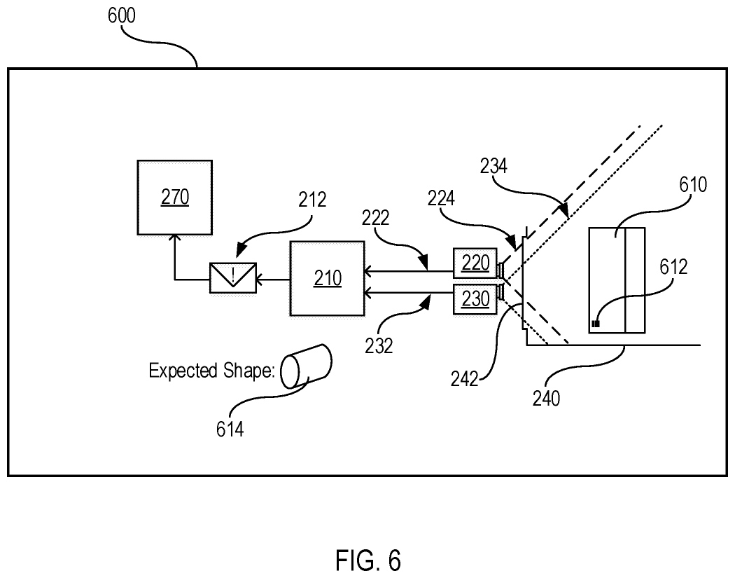

When a user moves the cylindrical item 130 across the platter 120, the indicia decoding device 100 gathers 2D image data and 3D depth data (see FIGS. 2-6) of the cylindrical item 130 through the viewing window 110. The indicia decoding device 100 verifies that the cylindrical item 130 has an indicium and that a shape of the cylindrical item 130 matches an expected shape associated with the indicium (see FIG. 6). When the user moves the first rectangular item 140 across the platter 120, the aforementioned process repeats.

When the user moves the second rectangular item 150 across the platter 120, the indicia decoding device 100 detects that the second rectangular item 150 lacks an indicium. Responsive to the determination that the second rectangular item 150 has crossed the platter 120 without the indicia decoding device 100 detecting an indicium that is associated with the second rectangular item 150, the indicia decoding device 100 sends a message to an alert module (see FIGS. 2 and 6).

It should be appreciated that FIG. 1 illustrates an example scenario, and that particular analyses performed and actions taken by the example indicia decoding device 100 are not intended to be limiting. The subsequent Figures provide additional detail regarding different scenarios, configurations, and behaviors of example indicia decoding devices.

FIG. 2 illustrates an example indicia decoding device 200 data flow when viewing two items side-by-side, according to an example embodiment to the present disclosure. The indicia decoding device 200 comprises a processing device 210, a 2D imaging assembly 220 with a 2D imaging field of view 224 (2D FOV 224), a depth imaging assembly 230 with a depth field of view 234 (depth FOV 234), a platter 240, and a viewing window 242. In the 2D FOV 224 and the depth FOV 234 are a first item 250 with an indicium 252 and a second item 260 without an indicium.

The 2D imaging assembly 220 may be a camera or any other device capable of capturing 2D images. The depth imaging assembly 230 may be a time of flight array, a structured light sensor, a 3D camera, stereoscopically-configured 2D cameras, or any combination thereof. In some embodiments, the 2D imaging assembly 220 is included in the depth imaging assembly 230. For example, when the depth imaging assembly 230 is a pair of stereoscopically-configured 2D cameras, the 2D imaging assembly 220 may comprise one or both of the stereoscopically-configured 2D cameras. The 2D imaging assembly 220 and the depth imaging assembly 230 may be positioned so that the 2D FOV 224 and the depth FOV 234 substantially overlap. The 2D imaging assembly 220 and the depth imaging assembly 230 may also be positioned to capture their respective fields of view from different angles.

The processing device 210 receives 2D data 222 from the 2D imaging assembly 220 and depth data 232 from the depth imaging assembly 230. The processing device 210 may be configured to accept data from one of the 2D imaging assembly 220 or the depth imaging assembly 230 until an item is detected, then begin accepting data from both the 2D imaging assembly 220 and the depth imaging assembly 230. The processing device 210 may also be configured to continuously monitor both the 2D data 222 and the depth data 232 regardless of the presence of an item.

In this example scenario, the first item 250 and the second item 260 have entered the 2D FOV 224 and the depth FOV 234. The processing device 210 receives 2D data 222 from the 2D imaging assembly 220 and depth data 232 from the depth imaging assembly 230 about the first item 250 and the second item 260. A graph 236 of the depth data 232 is provided for illustrative purposes.

The processing device 210 analyzes the depth data 232 to determine a number of items that are in the depth FOV 234 of the depth imaging assembly 230 during a period of time and determines that a gap 238 exists in the depth data 232. The processing device 210 checks a set of predetermined parameters to determine if at least one characteristic of the gap 238 exceeds a predetermined threshold. The characteristic may be a width, depth, length, volume, boundary between textures, boundary between curvatures, or any other physical metric. Responsive to a determination that a characteristic of the gap 238 does exceed a predetermined threshold, the processing device 210 concludes that a boundary between two items has been detected. In this example scenario, the processing device 210 determines that two total items are in the depth FOV 234. In some scenarios, the gap 238 may instead be a raised lip or bead, as would be found at a boundary between two stacked tuna cans. It should be appreciated that the processing device 210 may be configured to identify any feature in the depth data 232 that may correspond with a boundary between two items, and that the processing device 210 may be configured to combine detected characteristics from the depth data 232 with characteristics from the 2D data 222 such as, but not limited to, shape and color in order to identify boundaries between items. In some embodiments, the processing device 210 tracks the number of items over an extended period of time. For example, the processing device 210 may accumulate a total number of items that pass through the depth FOV 234 during the entirety of a transaction at self-service checkout kiosk.

The processing device 210 also analyzes the 2D data 222 to determine a number of indicia that are present in the 2D FOV 224 during at least a portion of the period of time. In this example scenario, the processing device 210 determines that one total indicium 252 is in the 2D FOV 224. In some embodiments, the processing device 210 tracks the number of indicia over an extended period of time. For example, the processing device 210 may accumulate a total number of indicia that pass through the 2D FOV 224 during the entirety of a transaction at self-service checkout kiosk. The indicia may be any computer-readable markings, including but not limited to universal product codes, quick response codes, linear barcodes, 2D barcodes, and text.

After analyzing the depth data 232 and the 2D data 222, the processing device 210 compares the total number of indicia with the total number of items. In this example scenario, the processing device 210 determines that the total number of indicia (1) does not match the total number of items (2). In some embodiments, the processing device 210 does not compare the number of indicia with the number of items until a user indicates that all items in a transaction have passed through the 2D FOV 224 and the depth FOV 234. For example, a user might select an option at a self-service checkout kiosk indicating that the user is ready to pay, thus indicating to the indicia decoding device 200 that all items in the transaction have passed through the 2D FOV 224 and the depth FOV 234.

Responsive to a determination that the number of items is not equal to the number of indicia, the processing device 210 sends a message 212 indicative of a non-decode event to an alert module 270. The message 212 may be transmitted over wire or wirelessly. Upon receipt of the message 212, the alert module 270 may send an alert to a human employee, send a notification to a cashier terminal, present the user with a notification, halt a transaction, take any other predefined action, or combinations thereof.

Responsive to a determination that the number of items is equal to the number of indicia, the processing device 210 may take no action, send a message 212 to the alert module 270 confirming that the number of items matches the number of indicia, take any other predefined action, or combinations thereof.

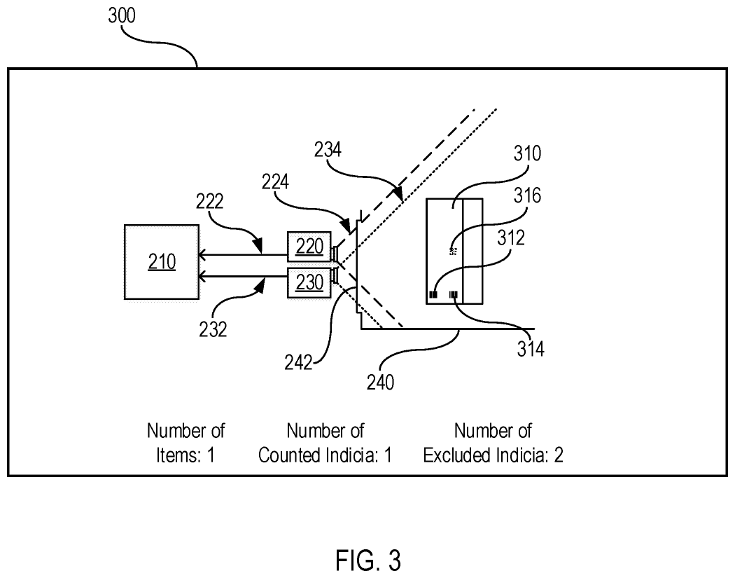

FIG. 3 illustrates an example indicia decoding device 300 data flow when viewing a single item 310 with multiple indicia, according to an example embodiment of the present disclosure. The indicia decoding device 300 comprises a processing device 210, a 2D imaging assembly 220 that has a 2D imaging field of view 224 (2D FOV 224), a depth imaging assembly 230 that has a depth imaging field of view 234 (depth FOV 234), a platter 240, and a viewing window 242 (see FIG. 2). The 2D imaging assembly 220 sends 2D data 222 to the processing device 210 and the depth imaging assembly 230 sends depth data 232 to the processing device 210 (see FIG. 2).

In this example scenario, an item 310 that has a first linear bar code indicium 312 (first linear indicium 312), a second linear bar code indicium 314 (second linear indicium 314), and a 2D bar code indicium 316 (2D indicium 316, collectively, the indicia 312, 314, and 316) has entered the 2D FOV 224 and the depth FOV 234. The processing device 210 receives 2D data 222 from the 2D imaging assembly 220 and depth data 232 from the depth imaging assembly 230 about the item 310.

In this example scenario, the processing device 210 is configured to determine whether multiple indicia 312, 314, and 316 are affixed to the item 310. Since indicia have many use cases that often overlap in scope, it is fairly common for an item to bear multiple indicia 312, 314, and 316. For the purposes of verifying that an indicium has been decoded for every item that passes over the platter 240, the processing device 210 may be configured to include one indicium of the multiple indicia 312, 314, and 316 in consideration when analyzing the 2D data 222 from the 2D imaging assembly 220 to determine a number of indicia and exclude additional indicia of the multiple indicia 312, 314, and 316 from consideration when analyzing the 2D data 222 from the 2D imaging assembly 220 to determine the number of indicia. Though the item 310 has more than one indicium, the processing device 210 will only increase the number of counted indicia by one. The processing device 210 may decode one or more the indicia 312, 314, and 316 and the processing device 210 may store the data from the one or more of the indicia 312, 314, and 316.

In other example scenarios, multiple items may be present in the 2D FOV 224 and the depth FOV 234 which may in turn have multiple indicia. For example, the item 310 may be accompanied by a second item that has five indicia of various formats, and the number of counted indicia would be two. In another example, the second item has no indicium and the number of counted indicia is one, causing a mismatch between the number of items and the number of indicia and causing the processing device 210 to send an alert message 212 to an alert module 270 (see FIG. 2).

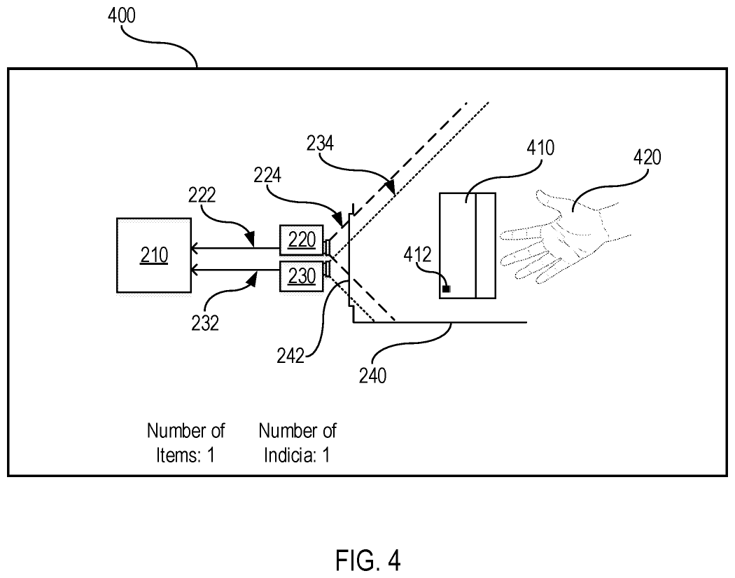

FIG. 4 illustrates an example indicia decoding device 400 data flow when viewing an item and a human hand, according to an example embodiment of the present disclosure. The indicia decoding device 400 comprises a processing device 210, a 2D imaging assembly 220 that has a 2D imaging field of view 224 (2D FOV 224), a depth imaging assembly 230 that has a depth imaging field of view 234 (depth FOV 234), a platter 240, and a viewing window 242 (see FIG. 2). The 2D imaging assembly 220 sends 2D data 222 to the processing device 210 and the depth imaging assembly 230 sends depth data 232 to the processing device 210 (see FIG. 2).

In this example scenario, a human hand 420 and an item 410 that has an indicium 412 have entered the 2D FOV 224 and the depth FOV 234. The processing device 210 receives 2D data 222 from the 2D imaging assembly 220 and depth data 232 from the depth imaging assembly 230 about the item 410 and the human hand 420.

In this example scenario, the processing device 210 is configured to identify a human hand 420 within at least one of the depth FOV 234 of the depth imaging assembly 230 or the 2D FOV 224 of the 2D imaging assembly 220. The processing device 210 may employ machine learning, gesture recognition, image pattern recognition, any other technique, or combinations thereof to identify the human hand 420.

The processing device 210 may be configured to exclude the human hand 420 from consideration when analyzing the depth data 232 from the depth imaging assembly 230 and the 2D data 222 from the 2D imaging assembly 220 to determine a number of items. Since a human hand 420 is unlikely to be an intended target item of the indicia decoding device 400 and is likely to be regularly encountered during operation of the indicia decoding device 400, the inclusion of the human hand 420 in the total number of indicia would cause the processing device 210 to erroneously and frequently increase the number of items counted. The processing device 210 may also be configured to detect and exclude other items from consideration that are likely to be frequently encountered during operation, including but not limited to wallets, purses, keys, money, payment cards, or any other item that is likely to cause erroneous increments of the counted number of items. In this example scenario, the number of counted items is one and the number of indicia is one, and the processing device 210 takes no action.

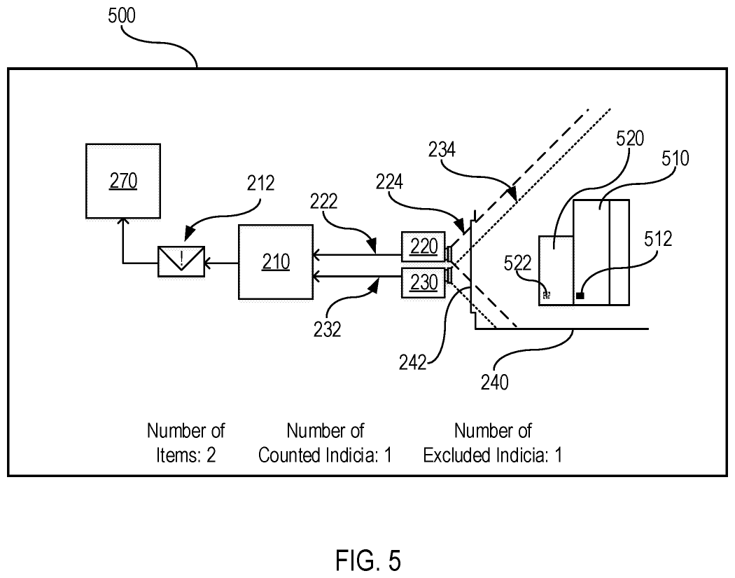

FIG. 5 illustrates an example indicia decoding device 500 data flow when viewing two items with different formats of indicia, according to an example embodiment of the present disclosure. The indicia decoding device 500 comprises a processing device 210, a 2D imaging assembly 220 that has a 2D imaging field of view 224 (2D FOV 224), a depth imaging assembly 230 that has a depth imaging field of view 234 (depth FOV 234), a platter 240, and a viewing window 242 (see FIG. 2). The 2D imaging assembly 220 sends 2D data 222 to the processing device 210 and the depth imaging assembly 230 sends depth data 232 to the processing device 210 (see FIG. 2).

In this example scenario, an first item 510 that has a linear bar code indicium 512 (linear indicium 512) and second item 520 that has a 2D bar code indicium 522 have entered the 2D FOV 224 and the depth FOV 234. The processing device 210 receives 2D data 222 from the 2D imaging assembly 220 and depth data 232 from the depth imaging assembly 230 about the first item 510 and the second item 520.

In this example scenario, the processing device 210 is configured to include indicia of a predetermined format in consideration when analyzing the 2D data 222 from the 2D imaging assembly 220 to determine a number of indicia and exclude additional indicia which are not of the predetermined format from consideration when analyzing the 2D data 222 from the 2D imaging assembly 220 to determine the number of indicia. The indicia decoding device 500 may be capable of decoding indicia of a broad variety of formats, but in many cases a single format containing desired information will be targeted across many items. The processing device 210 may also be configured to include a grouping of formats of indicia while excluding all others. The particular targeted format may be a universal price code, other linear bar code, quick response code, other 2D barcode, text, any other computer-readable indicium, or any combination thereof.

In this example scenario, the processing device 210 is configured to include linear bar code indicia, and thus linear indicium 512 is included in the number of counted indicia. The processing device 210 is also configured to exclude all other formats of indicia, such as the 2D bar code indicium 522. The number of counted indicia in this example is one while the number of counted items is two, resulting in a mismatch between the number of indicia and the number of items. The mismatch causes the processing device 210 to send a message 212 to an alert module 270 (see FIG. 2). In another example scenario, the second item 520 has an additional indicium that is a linear bar code indicium. Even though the second item 520 also has the 2D bar code indicium 522 which is of an excluded format, the additional linear bar code indicium is included in the number of counted indicia. In this new scenario, the number of indicia matches the number of items and the processing device 210 does not send a message 212 to the alert module 270.

FIG. 6 illustrates an example indicia decoding device 600 data flow when viewing an item 610 that does not match an expected shape 614 associated with an indicium 612 affixed to the item 610, according to an example embodiment of the present disclosure. The indicia decoding device 600 comprises a processing device 210, a 2D imaging assembly 220 that has a 2D imaging field of view 224 (2D FOV 224), a depth imaging assembly 230 that has a depth imaging field of view 234 (depth FOV 234), a platter 240, and a viewing window 242 (see FIG. 2). The 2D imaging assembly 220 sends 2D data 222 to the processing device 210 and the depth imaging assembly 230 sends depth data 232 to the processing device 210 (see FIG. 2).

In this example scenario, an item 610 that has an indicium 612 has entered the 2D FOV 224 and the depth FOV 234. The processing device 210 receives 2D data 222 from the 2D imaging assembly 220 and depth data 232 from the depth imaging assembly 230 about the item 610.

In this example scenario, the processing device 210 is configured to analyze the depth data 232 from the depth imaging assembly 230 to detect at least one of a size, shape, texture, or curvature of the item 610 that is in the depth FOV 234 of the depth imaging assembly 230. The processing device 210 is configured to then determine whether at least one of a known size, shape, texture, or curvature of a known item that corresponds to the indicium 612 that is in the 2D FOV 224 of the 2D imaging assembly 220 matches at least one of the detected size, shape, texture, or curvature of the identified item 610. The processing device 210 may also be configured to analyze the 2D data 222 to detect a color, visual pattern, or shape of the item 610 that can similarly be compared with a known color, visual pattern, or shape of the known item.

The processing device 210 may retrieve known characteristics of the known item that corresponds with the indicium 612 from a database, local storage, data encoded on the indicium 612 itself, data encoded on the item 610 separately from the indicium 612, or any other computerized data storage means. Data associated with a plurality of items for use by the processing device 210 may be manually created by a human, collected by the depth imaging assembly 230 and the 2D imaging assembly 220, created with machine learning, or any other means of generating and recording the data.

The comparison of a detected characteristic of the item 610 with a known characteristic of the known item may be accomplished through pattern recognition, machine learning, or any other method appropriate for comparing the relevant data. The processing device 210 may be configured with predetermined threshold values corresponding to a plurality of characteristics. These threshold values may determine how tolerant the processing device 210 is of deviations from the expected characteristic before determining that a mismatch has occurred.

In this example scenario, the processing device 210 is configured to transmit a message 212 to an alert module 270 responsive to determining that the known size, shape, texture, or curvature of the known item does not correspond to the detected size, shape, texture, or curvature of the identified item 610 (see FIG. 2). In other example scenarios, the processing device 210 detects that the item 610 and the expected shape 614 are within the predetermined threshold range for the appropriate characteristic. The processing device 210 is then configured to send a confirmation message 212 to the alert module 270.

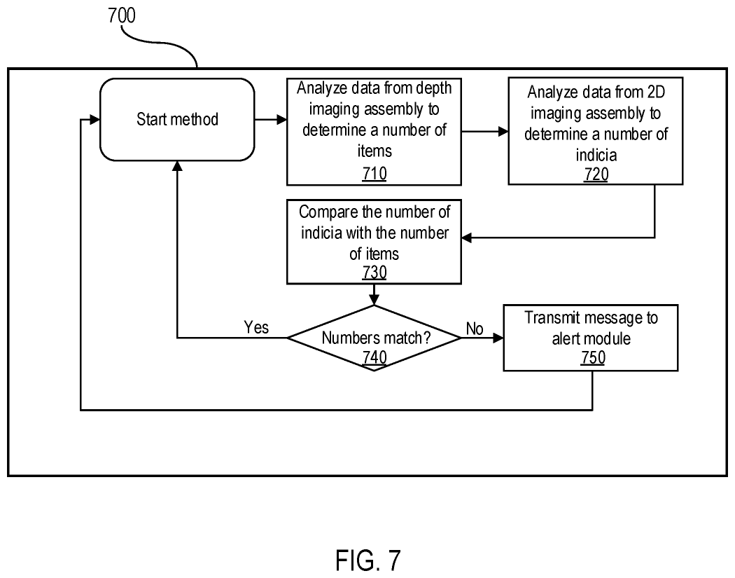

FIG. 7 illustrates a flow chart of an example method 700 for discerning the presence of multiple objects within a field of view of an imaging device for use with indicia decoding, according to an example embodiment of the present disclosure. It should be appreciated that the example method 700 is presented with a high level of abstraction, and that the blocks of the flow chart depicted in FIG. 7 may consist of a number of activities, some of which may not be described herein.

At block 710, a system analyzes data from a depth imaging assembly to determine a number of items that are in a field of view of the depth imaging assembly during a period of time (see FIGS. 2, 3, 4, and 5). The determination of the number of items may also include analysis of data from a 2D imaging assembly. The system then proceeds to block 720. In some embodiments, block 720 is executed before block 710. In some embodiments, block 720 and block 710 are executed simultaneously. The system may be configured to wait at block 710 for a determination that the number of items that are in the field of view of the depth imaging assembly is greater than one before proceeding to block 720.

At block 720, the system analyzes data from a 2D imaging assembly to determine a number of indicia that are present in a field of view of the 2D imaging assembly during at least a portion of the period of time (see FIGS. 2, 3, and 5). The system may use any of the analysis techniques described in the preceding Figures, additional analysis techniques not described herein, or combinations thereof. The system then proceeds to block 730.

At block 730, the system compares the number of indicia determined at block 720 with the number of items determined at block 710. This may be a direct comparison or an error threshold may be employed. For example, the system may be configured to allow a discrepancy of up to two items not having associated indicia before outputting negative comparison result. The system may also be configured with zero error tolerance; in such a configuration the system outputs a negative comparison result in any scenario where the counted number of items does not match the counted number of indicia. The system then proceeds to block 740.

At block 740, the system acts on the comparison result produced at block 730.

When the comparison result is positive (i.e. the number of items matches the number of indicia or is within a predetermined threshold), the system may return to the beginning of the method 700 and continuously loop blocks 710 through 740. In some examples, the system waits at block 740 for a new transaction to be initiated before returning to the start of the method 700.

When the comparison result is negative (the number of items does not match the number of indicia of a difference between them exceeds a predetermined threshold), the system proceeds to block 750.

At block 750, the system transmits an error message to an alert module (see FIG. 2) indicative of a non-decode event. The alert module may respond to the message by taking any of a number of actions or combinations thereof as described in FIG. 2. The system then proceeds back to the beginning of the method 700. In some examples, the system may wait at block 750 for a supervising human to unlock the system before it proceeds back to the beginning of the method 700. In this way, a user can be prevented from continuing a transaction despite a discrepancy between the number of items and the number of indicia.

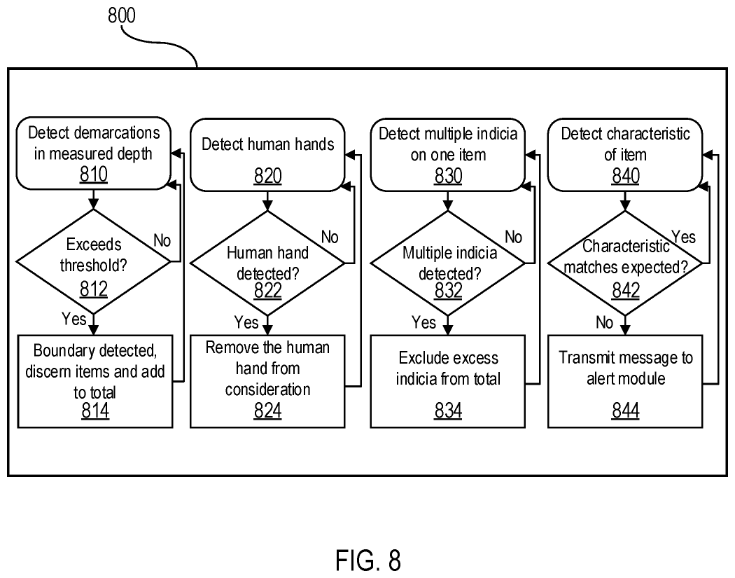

FIG. 8 illustrates a flow chart of a collection of example methods 800 for analyzing data from an imaging device for use with indicia decoding, according to an example embodiment of the present disclosure. It should be appreciated that the example methods 800 are presented with a high level of abstraction, and that the blocks of the flow chart depicted in FIG. 8 may consist of a number of activities, some of which may not be described herein.

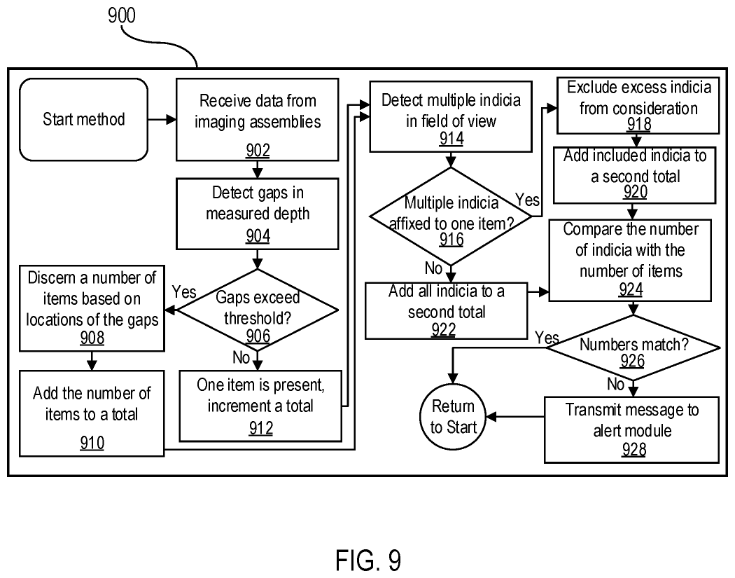

At block 810, a system initiates a method to detect demarcations in measured depth. This method may execute continuously and simultaneously with other methods. For example, all four methods in FIG. 8 may execute simultaneously. The method starting at block 810 may also execute periodically. For example, a system may sequentially execute the methods illustrated in FIG. 8 (see FIG. 9).

The system employs techniques described in FIG. 2 to determine where demarcations (i.e. gaps or raised features) in depth data and 2D data exist. The system then proceeds to block 812.

At block 812, the system compares the detected demarcations with predetermined threshold parameters (see FIG. 2). The system may analyze physical characteristics of the demarcations such as a width, depth, length, or combinations thereof. The system may also detect boundaries in color, texture, visual patterns, or combinations thereof and compare these features to threshold parameters. The system may assign a weight to each analyzed characteristic, and may combine the weighted data from multiple characteristics to produce a score that determines whether a threshold has been exceeded. The system may also enforce thresholds for individual characteristics, and may combine absolute thresholds for individual characteristics with a weighted scoring scheme to determine whether a threshold has been exceeded.

The system may also employ machine learning, pattern recognition, or combinations thereof in determining whether a threshold has been exceeded. In examples that employ machine learning, the threshold parameters may be manually created and stored by a human or may be generated during a machine learning training process.

When a detected demarcation exceeds a threshold, the system proceeds to block 814. This determination may be made for a batch of demarcations simultaneously. The system may produce a map of the demarcations that excludes any demarcations that do not exceed the threshold.

When no detected demarcations exceed a threshold, the system returns to block 810 to continue searching for demarcations. In some examples, the system may wait at block 812 for other methods to execute before proceeding to block 810.

At block 814, the system uses the detected demarcations that exceed a threshold to discern a plurality of items present in a field of view of the system. The field of view of the system may be a depth field of view, a 2D field of view, or a composite thereof (see FIG. 2). When a map of multiple demarcations is produced at block 812, the system may employ the map when discerning the plurality of items. A total number of items is incremented by one for each item discerned. The system then proceeds to block 810 to continue searching for demarcations. In some examples, the system may wait at block 814 for other methods to execute before proceeding to block 810.

At block 820, a system initiates a method to detect human hands. This method may execute continuously and simultaneously with other methods. For example, all four methods in FIG. 8 may execute simultaneously. The method starting at block 820 may also execute periodically. For example, a system may sequentially execute the methods illustrated in FIG. 8 (see FIG. 9). The system proceeds to block 822.

At block 822, the system determines whether a human hand has entered a field of view of the system. The system employs techniques described in FIG. 4 to discern a human hand. The system may employ machine learning, pattern recognition, or combinations thereof in determining whether a human hand has been detected. In examples that employ machine learning, detection parameters may be manually created and stored by a human or may be generated during a machine learning training process.

When a human hand is detected, the system proceeds to block 824.

When no human hand is detected, the system returns to block 820 to continue searching for human hands. In some examples, the system may wait at block 822 for other methods to execute before proceeding to block 820.

At block 824, the system removes the human hand from consideration when updating a counted number of items. In some examples, an update of the counted number of items may be performed by a different method which counts the human hand as an item. In such a scenario, the system may decrement the item count by one to compensate for the presence of the human hand. In other examples, the system flags the human hand for exclusion from the counted number of items. In this scenario, a different method may update the item count and exclude the human hand responsive the flag. The system then proceeds to block 820 to continue searching for human hands. In some examples, the system may wait at block 824 for other methods to execute before proceeding to block 820.

At block 830, a system initiates a method to detect multiple indicia affixed to a single item. This method may execute continuously and simultaneously with other methods. For example, all four methods in FIG. 8 may execute simultaneously. The method starting at block 830 may also execute periodically. For example, a system may sequentially execute the methods illustrated in FIG. 8 (see FIG. 9). The system proceeds to block 832.

At block 832, the system determines whether an item with multiple affixed indicia has entered a field of view of the system. The system may use a combination of depth data and 2D data to determine whether multiple indicia are affixed to a single item. The system may decode all or a portion of the indicia and may store all or a portion of data retrieved from the indicia.

When multiple indicia are determined to be affixed to a single item, the system proceeds to block 834.

When multiple indicia are not affixed to a single item, the system returns to block 830 to continue searching for multiple indicia affixed to a single item. In some examples, the system may wait at block 832 for other methods to execute before proceeding to block 830.

At block 834, the system removes excess indicia from consideration when determining the counted number of indicia (see FIG. 3). The system may limit an increment of the number of counted indicia to one per detected item. The system then proceeds to block 830 to continue searching for multiple indicia affixed to a single item. In some examples, the system may wait at block 834 for other methods to execute before proceeding to block 830.

At block 840, a system initiates a method to detect a characteristic of a current item (see FIG. 6). This method may execute continuously and simultaneously with other methods. For example, all four methods in FIG. 8 may execute simultaneously. The method starting at block 840 may also execute periodically. For example, a system may sequentially execute the methods illustrated in FIG. 8 (see FIG. 9).

The system detects a characteristic or characteristics of a current item that has entered a field of view of the system (see FIG. 6). The characteristic may be at least one of a size, shape, texture, curvature, color, or visual pattern of the current item. The system proceeds to block 842.

At block 842, the system compares the detected characteristic or characteristics of the current item with known characteristics of a known item that corresponds with an indicium affixed to the current item. The known characteristic may be determined by decoding an indicium and retrieving the known characteristic associated with the indicium. The known characteristic may be stored in a database external to the system or the system may retain a store of known characteristics associated with a plurality of indicia for reference. The system may output a comparison result that indicates whether the detected characteristic or characteristics match the known characteristics.

The system may employ threshold values associated with metrics of a characteristic in determining the comparison result. The system may also employ machine learning, pattern recognition, or combinations thereof to determine the comparison result. In examples that employ machine learning, characteristic comparison threshold values or parameters may be manually created and stored by a human or may be generated during a machine learning training process.

When the comparison result is negative (i.e. the detected characteristic or characteristics do not match the known characteristic or characteristics), the system proceeds to block 844.

When the comparison result is positive (i.e. the detected characteristic or characteristics match the known characteristic or characteristics within a predetermined threshold), the system returns to block 840 to continue detecting characteristics of items. In some examples, the system may wait at block 842 for other methods to execute before proceeding to block 840.

At block 844, the system transmits a message to an alert module (see FIG. 6). The system then proceeds to block 840 to continue searching for multiple indicia affixed to a single item. In some examples, the system may wait at block 844 for a supervising human to unlock the system before proceeding to block 840 (see FIG. 7, block 750).

FIG. 9 illustrates a flow chart of an example method 900 for analyzing data from an imaging device for use with indicia decoding, according to an example embodiment of the present disclosure. It should be appreciated that the example method 900 is presented with a high level of abstraction, and that the blocks of the flow chart depicted in FIG. 9 may consist of a number of activities, some of which may not be described herein.

At block 902, a system receives data from a depth imaging assembly and a 2D imaging assembly (see FIG. 2). The receipt of data may be triggered by an item moving into a depth field of view, a 2D field of view, or a composite field of view made up of a combination of the 2D field of view and the depth field of view. The system then proceeds to block 904.

At block 904, the system detects gaps in the depth data obtained at block 902. Further detail regarding blocks 904, 906, 908, and 910 may be found in the method starting at block 810 of FIG. 8 and in FIG. 2. The system measures characteristics associated with the gaps such as depth, width, length, or combinations thereof.

At block 906, the system determines whether detected gaps exceed a predetermined threshold. Further detail regarding blocks 904, 906, 908, and 910 may be found in the method starting at block 810 of FIG. 8 and in FIG. 2. The system compares the characteristics measured at block 904 with predetermined threshold values to determine whether a boundary between items exists.

When one or more gaps exceeds the predetermined threshold, the system proceeds to block 908.

When no gaps exceed the predetermined threshold, the system proceeds to block 912.

At block 908, the system uses the gaps identified as exceeding the threshold at block 906 to discern a number of items that are in a field of view of the system. Further detail regarding blocks 904, 906, 908, and 910 may be found in the method starting at block 810 of FIG. 8 and in FIG. 2. The system then proceeds to block 910.

At block 910, the system increments the number of counted items to reflect the items discerned at block 908. Further detail regarding blocks 904, 906, 908, and 910 may be found in the method starting at block 810 of FIG. 8 and in FIG. 2. Before incrementing the number of counted items, the system may check for human hands or excluded item categories (see FIGS. 8 and 4) and may alter the increment value if a human hand or excluded item is detected. The system then proceeds to block 914.

At block 912, the system has determined that no boundaries between two items exist in the field of view of the system. The system thus concludes that one item is present. The system accordingly increments the number of counted items. The system may check for human hands or excluded item categories before incrementing the number of counted items (see FIGS. 8 and 4) and may proceed without incrementing if a human hand or excluded item is detected. The system then proceeds to block 914.

At block 914, the system detects that multiple indicia are simultaneously in the field of view of the system. Further detail regarding blocks 914, 916, 918, and 920 can be found in the method starting at block 830 of FIG. 8 and in FIG. 3. The system may overlay a map of indicia locations with a map of locations of the items discerned in blocks 904-912. The system then proceeds to block 916.

At block 916, the system determines whether multiple indicia are affixed to a single item. Further detail regarding blocks 914, 916, 918, and 920 can be found in the method starting at block 830 of FIG. 8 and in FIG. 3. The system may use the overlay of the item locations and the indicia location created at block 914 in making the determination.

When the system determines that multiple indicia are affixed to a single item, the system proceeds to block 918 to adjust the number of indicia being added to the number of counted indicia.

When the system determines that no more than one indicium is affixed to each item, the system proceeds to block 922.

At block 918, the system flags indicia affixed to an item in excess of one for exclusion from the numbered counted indicia. Further detail regarding blocks 914, 916, 918, and 920 can be found in the method starting at block 830 of FIG. 8 and in FIG. 3. The system may still decode the excess indicia and store information extracted from the excess indicia; the exclusion of the excess indicia may only apply to determining a number of counted indicia. The system then proceeds to block 920.

At block 920, the system increments the total number of counted indicia by a value equal to a number of detected indicia that are not excluded at block 918. Further detail regarding blocks 914, 916, 918, and 920 can be found in the method starting at block 830 of FIG. 8 and in FIG. 3. The system then proceeds to block 924.

At block 922, the system has determined that no item within the field of view of the system has multiple affixed indicia. The system therefore increments the number of counted indicia by a value equal to a number of detected indicia. The system then proceeds to block 924.

At block 924, the system compares the number of counted indicia with the number of counted items. Further detail can be found in FIG. 2. The system may output a positive comparison result when the number of counted indicia is equal to or within a predetermined threshold range of the number of counted items. The system may output a negative comparison result when the number of counted indicia is not equal to or outside of a predetermined threshold range of the number of counted items. The method then proceeds to block 926.

At block 926, the system may take action responsive to the determination at block 924. Further detain can be found in FIG. 2.

When the comparison result at block 924 is positive, the system may proceed back to the start of the method at block 902 to continuously loop the data analysis. In other examples, the system may wait at block 926 for other methods to execute before returning to block 902.

When the comparison result at block 924 is negative, the system proceeds to block 928.

At block 928, the system transmits a message to an alert module (see FIG. 2). The system may then proceed back to the start of the method at block 902 to continuously loop the data analysis. In other examples, the system may wait at block 928 for a human supervisor to unlock the system. In some examples, the system may wait at block 928 for other methods to execute before proceeding to block 902.

It will be appreciated that the various features, methods, and devices described herein may be combined in any manner to suit the particular needs of real-world implementations.

It will also be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various aspects of the disclosure.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Accordingly, the scope of the invention should be determined not by the embodiments illustrated, but by the appended claims and their equivalents.

1. An imaging device for use with indicia decoding operations comprising:
a processing device;
a 2D imaging assembly; and
a depth imaging assembly, wherein the processing device is configured to:
analyze data from the depth imaging assembly to determine a number of items that are in a field of view of the depth imaging assembly during a period of time;
analyze data from the 2D imaging assembly to determine a number of indicia that are present in a field of view of the 2D imaging assembly during at least a portion of the period of time;
compare the number of indicia with the number of items;
output a determination as to whether the number of indicia matches the number of items; and
responsive to determining that the number of indicia does not match the number of items, transmit a message to an alert module.

2. The imaging device of claim 1, wherein the imaging device is configured to discern multiple items by detecting a gap in a measured depth that exceeds a predetermined threshold.

3. The imaging device of claim 1, wherein the imaging device is configured to identify a human hand within at least one of the field of view of the depth imaging assembly or the field of view of the 2D imaging assembly.

4. The imaging device of claim 3, wherein responsive to identifying the human hand, the imaging device is configured to exclude the human hand from consideration when analyzing the data from the depth imaging assembly and the data from the 2D imaging assembly.

5. The imaging device of claim 1, wherein the processing device is further configured to:
determine whether multiple indicia are affixed to a single item; and
responsive to determining that multiple indicia are affixed to the single item, include one indicium of the multiple indicia in consideration when analyzing the data from the 2D imaging assembly to determine the number of indicia and exclude additional indicia of the multiple indicia from consideration when analyzing the data from the 2D imaging assembly to determine the number of indicia.

6. The imaging device of claim 1, wherein the processing device is further configured to include indicia of a predetermined format in consideration when analyzing the data from the 2D imaging assembly to determine the number of indicia and exclude additional indicia which are not of the predetermined format from consideration when analyzing the data from the 2D imaging assembly to determine the number of indicia.

7. The indicia decoding device of claim 6, wherein the predetermined format is a universal product code.

8. The imaging device of claim 1, wherein the imaging device is configured to analyze the data from the 2D imaging assembly responsive to a determination that the number of items that are in the field of view of the depth imaging assembly is greater than one.

9. The imaging device of claim 1, wherein the alert module sends a notification to a cashier terminal responsive to receiving a message from the processing device.

10. The imaging device of claim 1, wherein the depth imaging assembly includes at least one of a time of flight array, a structured light sensor, a 3D camera, or stereoscopically-configured 2D cameras.

11. The imaging device of claim 1, wherein the processing device is further configured to:
analyze the data from the depth imaging assembly to detect at least one of a size, shape, texture, or curvature of an identified item of the items that are in the field of view of the depth imaging assembly;
determine whether at least one of a known size, shape, texture, or curvature of a known item that corresponds to an indicium that is in the field of view of the 2D imaging assembly matches at least one of the detected size, shape, texture, or curvature of the identified item; and
responsive to determining that the known size, shape, texture, or curvature of the known item does not correspond to the detected size, shape, texture, or curvature of the identified item, transmit a message to an alert module.

12. A method for discerning the presence of multiple objects within a field of view of an imaging device for use with indicia decoding, comprising:
receiving data from a depth imaging assembly and a 2D imaging assembly;
analyzing the data to determine a number of items that are in a field of view of the depth imaging assembly during a period of time and a number of indicia that are present in a field of view of the 2D imaging assembly during at least a portion of the period of time;
comparing the number of indicia with the number of items;
determining whether the number of indicia matches the number of items; and
responsive to a determination that the number of indicia does not match the number of items,
transmitting a message to an alert module.

13. The method of claim 12, wherein the analyzing includes discerning multiple items by detecting a gap in a measured depth that exceeds a predetermined threshold

14. The method of claim 12, wherein the analyzing includes identifying a human hand within the at least one of the field of view of the depth imaging assembly or the field of view of the 2D imaging assembly

15. The method of claim 14, wherein responsive to identifying the human hand, the analyzing excludes the human hand from consideration when determining the number of items that are in the field of view of the depth imaging assembly.

16. The method of claim 12, wherein the analyzing includes:
determining whether multiple indicia are affixed to a single item; and
responsive to determining that multiple indicia are affixed to the single item, including one indicium of the multiple indicia in consideration when analyzing the data from the 2D imaging assembly to determine the number of indicia and excluding additional indicia which are affixed to the single item from consideration when analyzing the data from the 2D imaging assembly to determine the number of indicia.

17. The method of claim 12, wherein the analyzing the data includes detecting a gap in a measured depth that exceeds a predetermined threshold.

18. The method of claim 12, further comprising:
detecting at least one of a size, shape, or curvature of an identified item of the items that are in the field of view of the depth imaging assembly;
determining whether at least one of a known size, shape, or curvature of a known item that corresponds to an indicium that is in the field of view of the 2D imaging device matches at least one of the detected size, shape, or curvature of the identified item; and
responsive to determining that the known size, shape, or curvature of the known item does not correspond to the detected size, shape, or curvature of the identified item, transmitting a message to an alert module.

19. The method of claim 12, further comprising:
determining whether multiple indicia are affixed to a single item; and
responsive to determining that multiple indicia are affixed to the single item, including one indicium of the multiple indicia in consideration when analyzing the data from the 2D imaging assembly to determine the number of indicia and exclude additional indicia of the multiple indicia from consideration when analyzing the data from the 2D imaging assembly to determine the number of indicia.

20. A non-transitory computer-readable medium containing instructions which, when executed by a processing device, cause the processing device to:
analyze data from a depth imaging assembly to determine a number of items that are in a field of view of the depth imaging assembly during a period of time, wherein the processing device discerns a boundary between items at least partially by detecting a gap in a measured depth that exceeds a predetermined threshold;
analyze data from a 2D imaging assembly to determine a number of indicia that are present in a field of view of the 2D imaging assembly during at least a portion of the period of time, wherein the processing device determines whether multiple indicia are affixed to a single item, and responsive to determining that multiple indicia are affixed to the single item, the processing device includes one of the multiple indicia in consideration when determining the number of indicia and excludes additional indicia of the multiple indicia from consideration when determining the number of indicia;
compare the number of indicia with the number of items;
output a determination as to whether the number of indicia matches the number of items; and
responsive to determining that the number of indicia does not match the number of items, transmit a message to an alert module.
